(19) United States
(12) Patent Application Publication
(10) Pub. No.: US 2018/0286059 A1
(43) Pub. Date: Oct. 4, 2018

(54) DETERMINING SURFACE ROUGHNESS

(71) Applicant: ROLLS-ROYCE plc, London (GB)

(72) Inventors: Murukeshan VADAKKE MATHAM, Singapore (SG); Aswin HARIDAS, Singapore (SG); Alexandru CRIVOI, Singapore (SG); Prabhathan PATINHAREKANDY, Singapore (SG)

(73) Assignee: ROLLS-ROYCE plc, London (GB)

(21) Appl. No.: 15/944,247

(22) Filed: Apr. 3, 2018

(30) Foreign Application Priority Data
Apr. 4, 2017 (GB) 1705405.7

(51) Int. Cl. G06T 7/48; G06T 7/194; G06T 7/136; G01B 11/30

(52) U.S. Cl. CPC G06T 7/48; G06T 7/194; G06T 2207/10048; G01B 11/303; G06T 7/136

(57) ABSTRACT

A measurement system (301) for determining surface roughness is shown. A coherent illumination device (303) illuminates the surface of, for example, a component (201) with coherent light. An imaging device (304) obtains an image of speckle caused by the scattering of the coherent light from the surface. A processing device (305) converts the image into a binary image according to a threshold, thereby classifying pixels below the threshold as background pixels and pixels above the threshold as foreground pixels. It then evaluates the fractal dimension of the binary image. The fractal dimension correlates with surface roughness. An indication of the surface roughness of the surface is then outputted.

### CROSS-REFERENCE TO RELATED APPLICATION

This application is based upon and claims the benefit of priority from British Patent Application Number 1705405.7 filed Apr. 4, 2017, the entire contents of which are incorporated by reference.

### BACKGROUND

### Field of Disclosure

This disclosure relates to methods and systems for determining the roughness of surfaces.

### Description of Related Art

Optical methods of surface roughness characterisation are well-established. A known approach is to illuminate a surface with coherent light from a laser. The light scattered from the surface may then be directly imaged, allowing capture of a speckle pattern. As the speckle pattern is caused by constructive and destructive interference of the laser light, which is at least in part dependent upon the surface geometry down to the wavelength scale, the image of the speckle pattern may be processed to estimate the surface roughness.

However, problems exist in terms of optimising the efficiency of the image processing pipeline such that the technique may be used for on-line surface roughness measurement.

### SUMMARY

The invention is directed towards methods of and systems for determining surface roughness.

The method includes obtaining an image of speckle caused by the scattering of coherent light from a surface. Then, the image is converted into a binary image according to a threshold, thereby classifying pixels below the threshold as background pixels and pixels above the threshold as foreground pixels. Then, the fractal dimension of the binary image is evaluated, wherein the fractal dimension correlates with surface roughness. An indication of the surface roughness of the surface is then outputted.

There is also provided a measurement system which implements the method, and instructions executable by a computer which cause the computer to perform the method.

### BRIEF DESCRIPTION OF THE DRAWINGS

Embodiments will now be described by way of example only with reference to the accompanying drawings, which are purely schematic and not to scale, and in which:

FIG. 1 shows a sectional side view of a turbofan engine;

FIG. 2 shows a plan view of the fan of the engine of FIG. 1;

FIG. 3 shows a measurement system according to the present invention;

FIG. 4 shows components within the processing device forming part of the measurement system of FIG. 3;

FIG. 5 shows steps carried out by the measurement system to determine surface roughness;

FIG. 6 shows steps carried out to obtain images of the speckle caused by the scattering of coherent light from a surface;

FIGS. 7A, 7B and 7C show images of the speckle obtained by the method of FIG. 6;

FIG. 8 shows steps carried out to process the images obtained by the method of FIG. 6;

FIG. 9 shows steps carried out to produce binary images;

FIGS. 10A, 10B and 100 show binary images produced by the method of FIG. 9;

FIG. 11 shows steps carried out to determine the fractal dimension of the binary images; and

FIG. 12 shows a plot of fractal dimension against surface roughness.

### DETAILED DESCRIPTION

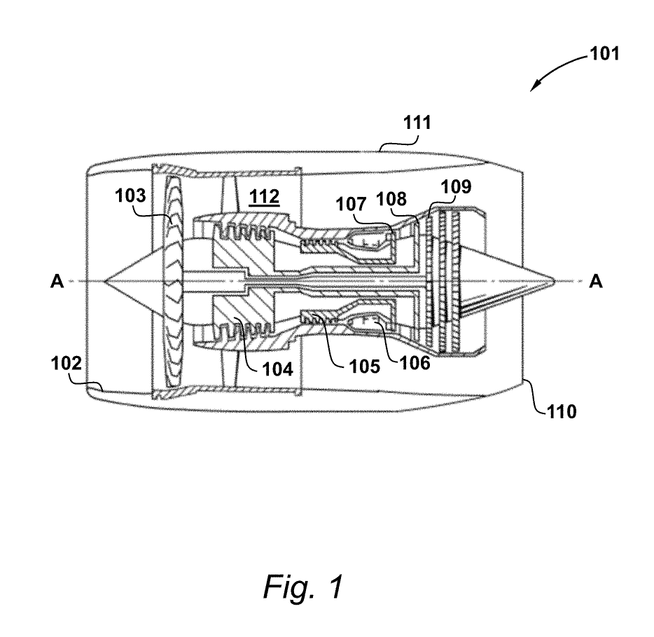

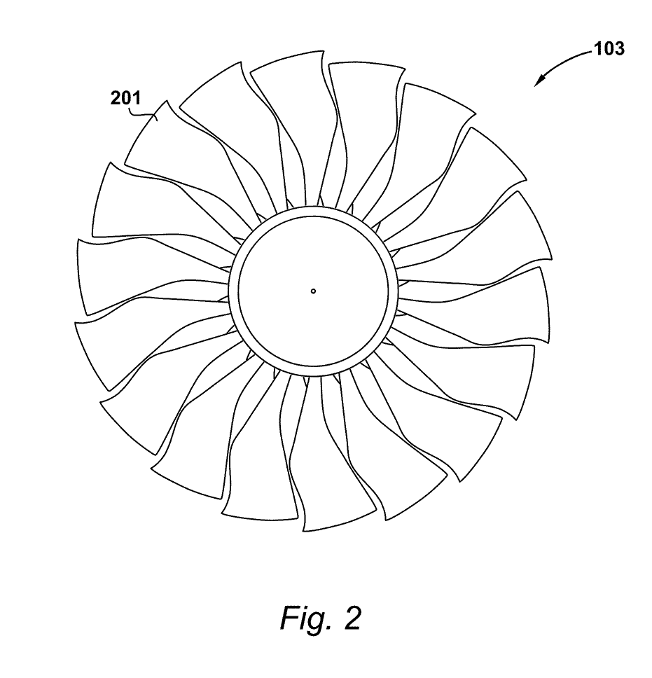

A turbofan engine is shown in FIG. 1, with its fan being shown in plan view in FIG. 2.

The engine 101 has a principal and rotational axis A-A and comprises, in axial flow series, an air intake 102, a propulsive fan 103, an intermediate pressure compressor 104, a high-pressure compressor 105, combustion equipment 106, a high-pressure turbine 107, an intermediate pressure turbine 108, a low-pressure turbine 109, and an exhaust nozzle 110. A nacelle 111 generally surrounds the engine 101 and defines both the intake 102 and the exhaust nozzle 110.

The engine 101 works in the conventional manner so that air entering the intake 102 is accelerated by the fan 103 to produce two air flows: a first air flow into the intermediate pressure compressor 104 and a second air flow which passes through a bypass duct 112 to provide propulsive thrust. The intermediate pressure compressor 104 compresses the air flow directed into it before delivering that air to the high pressure compressor 105 where further compression takes place.

The compressed air exhausted from the high-pressure compressor 105 is directed into the combustion equipment 106 where it is mixed with fuel and the mixture combusted. The resultant hot combustion products then expand through, and thereby drive the high pressure turbine 107, intermediate pressure turbine 108, and low pressure turbine 109 before being exhausted through the nozzle 110 to provide additional propulsive thrust. The high pressure turbine 107, intermediate pressure turbine 108, and low pressure turbine 109 drive respectively the high pressure compressor 105, intermediate pressure compressor 104, and fan 103, each by a suitable interconnecting shaft.

As the fan 103 is the one of the first components encountered by air entering the intake 102 of the engine 101, it is particularly important to ensure that the blades 201 of the fan 103, identified in FIG. 2, are optimised aerodynamically.

Many developments have therefore taken place in terms of improving fan blade geometry (i.e. on the macro scale). This has resulted in fan blades, such as those forming part of the fan 103, having complex surfaces with high degrees of variation in curvature.

However, it is also important to ensure that air flow is optimised by ensuring the surface roughness of the fan blades 201 is within acceptable limits (i.e. on the micro scale).

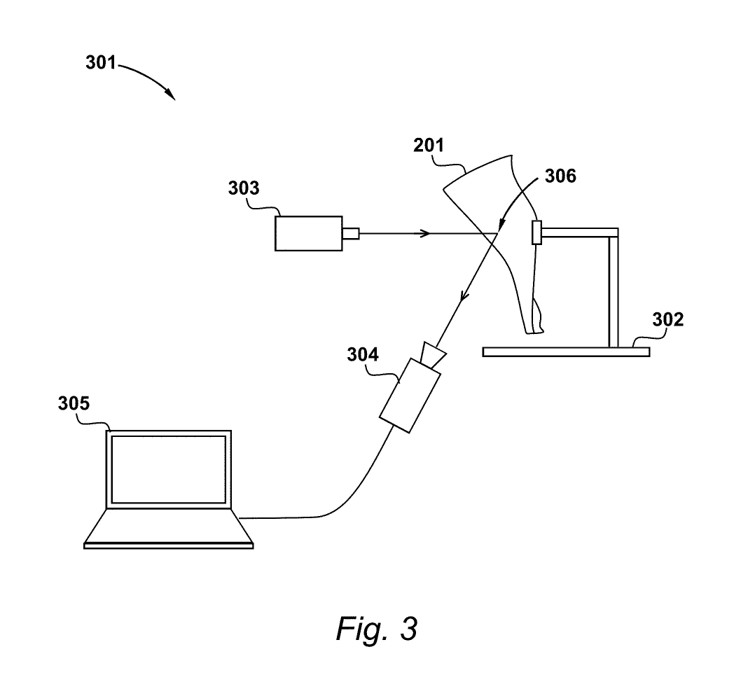

A measurement system for determining the roughness of a surface according to an aspect of the present invention is illustrated in FIG. 3.

The measurement system is indicated generally at 301, and may be employed for determining the roughness of the fan blade 201 to ensure its surface roughness meets the design specification. However, it will be appreciated that the principles employed by the system allow it to be used for measurement of the roughness of any surface, such as bearings, or the ball of a prosthesis, etc.

Measurement system 301 includes a fixture 302 in which a component may be mounted, such as the fan blade 201 in this example. The exact configuration of the fixture 302 will be understood by those skilled in the art as not being central to the present invention, and instead any fixture in which the component whose roughness is being measured may be held can be used.

A coherent illumination device such as, in this example, a laser 303 is provided to illuminate the surface of the component being analysed. In the present example, the laser 303 is an infrared laser configured to output coherent light at a wavelength of 1064 nanometres at a power of 80 watts. It will be appreciated that different wavelengths and/or different output powers may be adopted depending upon the particular application of the measurement system. Furthermore, the beam width may be selected to match the desired sample area and thus is dependent on the component and the parameters of the testing being undertaken. Thus in an example, an appropriate optical arrangement may be provided to broaden or narrow, and then collimate the light emanating from the laser 303.

In operation, laser light from the laser 303 is directed towards to surface of the component, and is scattered. Due to the generally rough surface of the component, the path length of the wavefronts is such that interference occurs and the intensity of the light varies across the scattered light field. Thus the scattered light field is related to the surface geometry which caused the scattering.

The scattered light field is therefore imaged by an imaging device, which in this example is a camera 304. The camera 304 is in the present example an infrared-sensitive indium gallium arsenide (InGaAs) camera, which in the present example is fitted with a 25 millimetre lens with a fixed aperture of f/16. Of course, it will be appreciated by those skilled in the art that the particular imaging device may be chosen in dependence upon the specifications of the illumination device. In addition, or alternatively, the choice of lens aperture and focal length may be varied, possibly in dependence on the illumination level and/or the size of component being imaged.

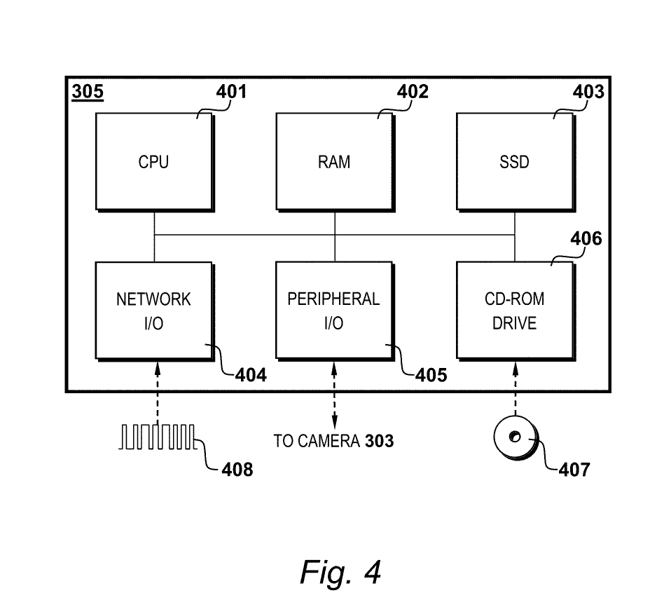

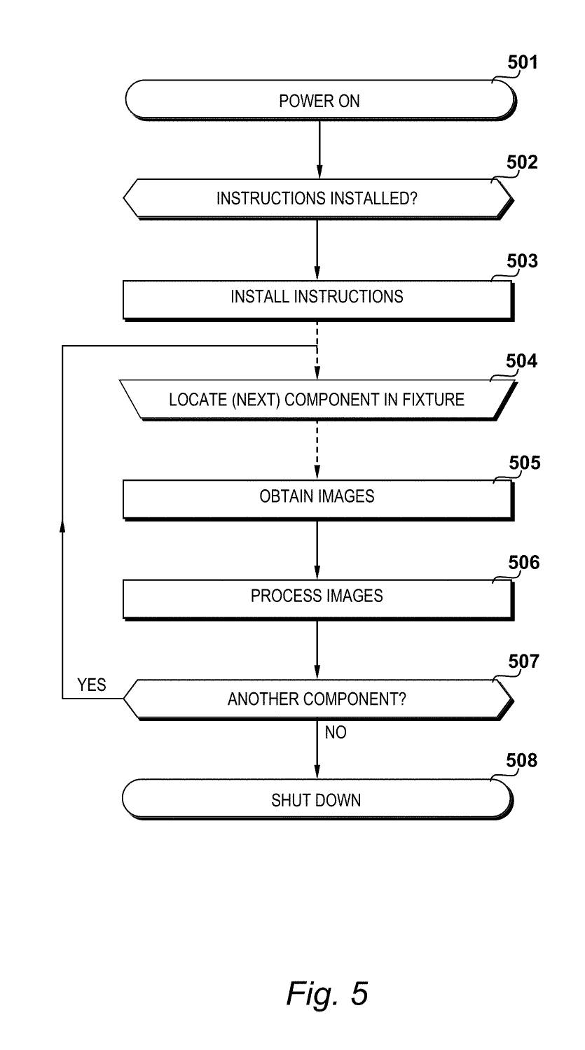

The measurement system 301 further comprises a processing device such as, in this example, a personal computer 305 to store and process the images obtained by the camera 304. The devices within the personal computer 305 which enable it to process the images will be described with reference to FIG. 4, whilst the instructions it executes will be described with reference to FIGS. 5 to 12.

In use, the measurement system 301 facilitates determination of the surface roughness by illuminating the surface of the component at a point 306 with coherent light produced by the laser 303. An image of speckle caused by the scattering of the coherent light from the surface is then obtained by the camera 304.

The image is then converted by the personal computer 305 into a binary image according to a threshold, thereby classifying pixels below the threshold as background pixels and pixels above the threshold as foreground pixels. The fractal dimension of the binary image is then evaluated. The fractal dimension is a statistical index of the complexity of the image, and it has been shown by the present inventors to correlate to the actual surface roughness. An indication of the surface roughness of the surface may then be outputted.

Devices within the personal computer 305 are illustrated in FIG. 4.

The personal computer 305 comprises a processor such as a central processing unit (CPU) 401. In this instance, central processing unit 401 is a single Intel® Core i7 processor, having four on-die processing cores operating at 3.2 gigahertz. It is of course possible that other processor configurations could be provided, and indeed several such processors could be present to provide a high degree of parallelism in the execution of instructions.

Memory is provided by random access memory (RAM) 402, which in this example is double data rate (DDR) SDRAM totaling 8 gigabytes in capacity. RAM 402 allows storage of frequently-used instructions and data structures by the personal computer 305. A portion of RAM 402 is reserved as shared memory, which allows high speed inter-process communication between applications running on personal computer 305.

Permanent storage is provided by a storage device such a solid-state disk (SSD) 403, which in this instance has a capacity of 512 gigabytes. SSD 403 stores operating system and application data. In alternative embodiments, a hard disk drive could be provided, or several storage devices provided and configured as a RAID array to improve data access times and/or redundancy.

A network interface 404 allows personal computer 305 to connect to a packet-based network such as the Internet. Additionally, personal computer 305 comprises a peripheral interface 405 such as a universal serial bus (USB®). In this embodiment, the peripheral interface 405 connects the personal computer 305 to the camera 304 to allow transfer of the images obtained in use. Whilst the peripheral interface 405 in the present embodiment is a wired USB® connection, it is contemplated that other connection types may be used such as wireless connections using, for example, an 802.11x standard.

Personal computer 305 also comprises an optical drive, such as a CD-ROM drive 406, into which a non-transitory computer readable medium such as an optical disk, e.g. CD-ROM 407 can be inserted. CD-ROM 407 comprises computer-readable instructions to enable the processing method of the present invention. These are, in use, installed on solid-state disk 403, loaded into RAM 402 and then executed by CPU 401. Alternatively, the instructions may be downloaded from a network via the network interface 404 as packet data 408.

It is to be appreciated that the above system is merely an example of a configuration of system that can fulfil the role of personal computer 305. Any other system having a processing device, memory, a storage device and a network interface could equally be used. Thus in an alternative embodiment it is envisaged that an application-specific integrated circuit (ASIC) or field-programmable gate array (FPGA) could be configured with the same instructions so as to perform substantially the same operations as the personal computer 305.

Operations carried out with the measurement system 301 in practice are detailed in FIG. 5.

At step 501, the measurement system 301, comprising the laser 302, the camera 304 and personal computer 305, is powered on. At step 502 a question is asked as to whether image processing instructions have been installed on the personal computer 305. If not, then at step 503 the instructions are obtained either from CD-ROM 407 or via the network connection 404 as previously described. Following install, or if the instructions have previously been installed, then at step 504 a manual procedure is carried out consisting of locating a component, such as fan blade 201, in the fixture 302.

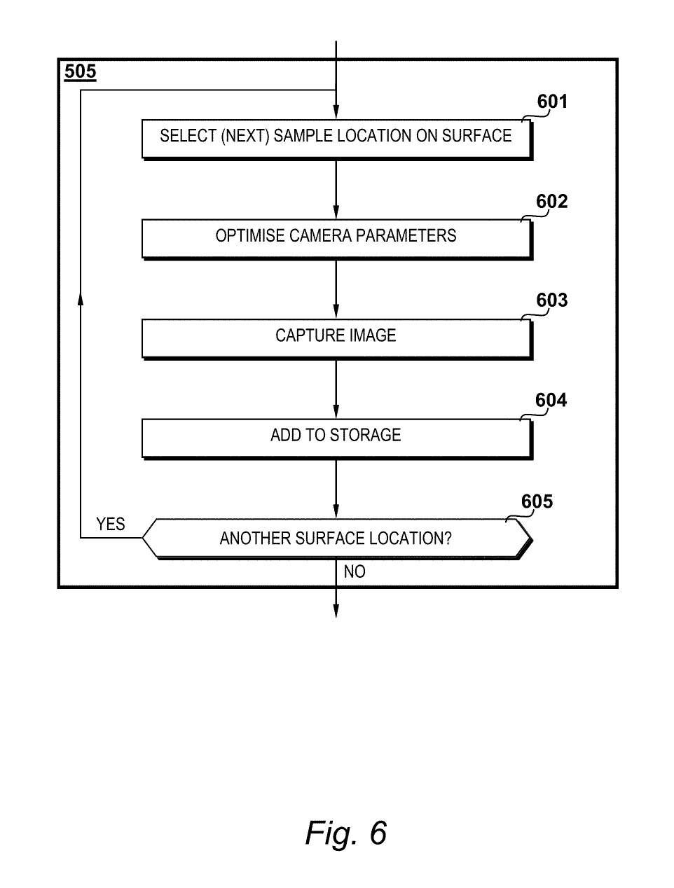

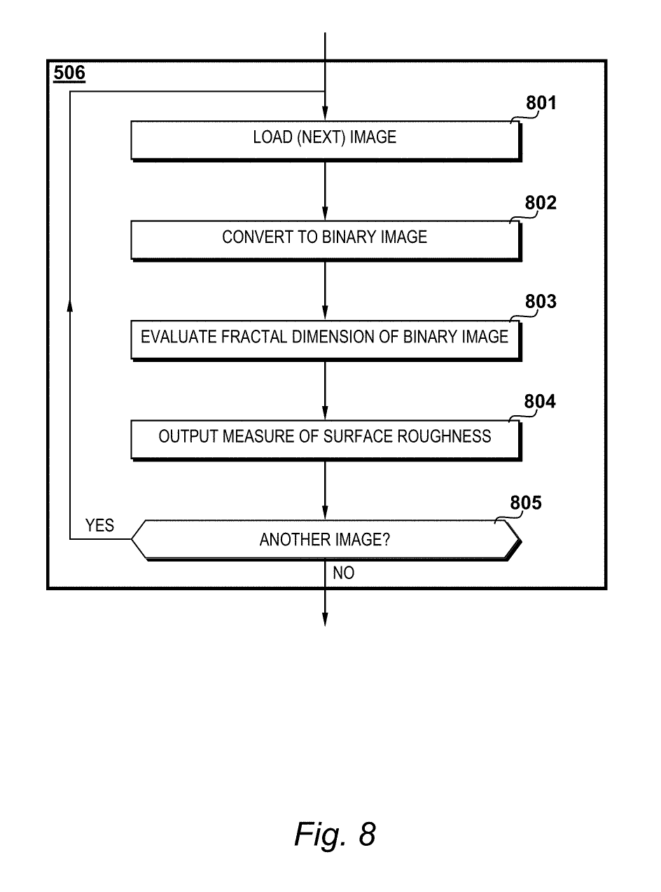

The measurement system 301 then captures images at step 505, and processes them at step 506. Procedures carried out to capture images during step 505 will be described with reference to FIG. 6, whilst procedures carried out to process the images will be described with reference to FIGS. 8, 9 and 11.

Following processing of the images, a question is asked at step 507 as to whether another component is to be analysed. If this question is answered in the affirmative, then control returns to step 504 where the new component is located in the fixture 302. If the question asked at step 507 is answered in the negative, then at step 508 the measurement system is shut down.

A procedure carried out during step 505 to obtain the images of the speckle caused by the scattering of the laser light from the surface of the component are set out in FIG. 6.

At step 601, a sample location on the surface of the component being imaged is selected. Depending on the size of the component, the width of the beam produced by laser 303, and the requirements of the particular test regime being carried out, it will be appreciated that the sample location chosen may be one of few (perhaps even one), or one of a large number. In this step, the laser 303 and camera 304 may be positioned and angled to illuminate and collect light from the sample location.

At step 602, the camera parameters are selected to produce a correct exposure. In the present example, the camera 304 has a fixed aperture lens and so in this step a metering operation takes place in which exposure length and sensor sensitivity are adjusted to give a correct exposure. Such procedures are known.

At step 603, an exposure is taken of the speckle pattern caused by the scattering of the laser light by the surface at the sample location. The image produced by the camera 304 is then transmitted at step 604 to the personal computer 305, whereupon it may be committed to storage on the solid-state disk 403.

At step 605, a question is asked as to whether any further surface locations are to be sampled. If so, then control returns to step 601 and the above procedures are repeated. If the question asked at step 605 is answered in the negative, then all surface locations have been imaged and step 505 is complete.

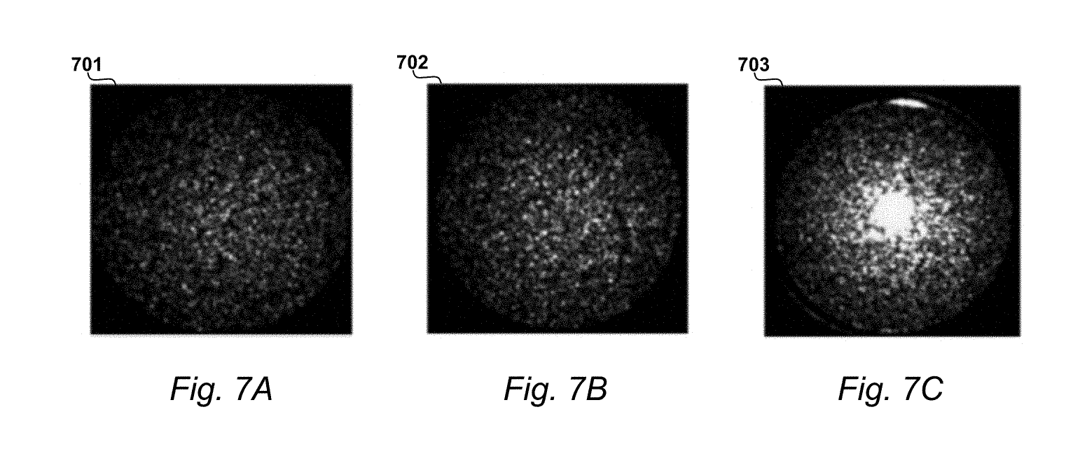

An image 701 is shown in FIG. 7A, and is the speckle pattern of a surface location where the roughness was equivalent to 220 grit.

An image 702 is shown in FIG. 7B, and is the speckle pattern of a surface location where the roughness was equivalent to 600 grit.

An image 703 is shown in FIG. 7C, and is the speckle pattern of a surface location where the roughness was equivalent to 1500 grit.

As may be discerned from the images 701, 702 and 703, the coarser the surface (the lower grit value in the present example), the lower the contrast in the image. The present invention therefore utilises an image processing scheme to quantify the differences between the speckle patterns caused by surfaces of different roughness, thereby allowing a determination to be made as to the roughness of the surface.

Steps carried out in the present embodiment by the personal computer 305 to process the images in step 506 are set out in FIG. 8.

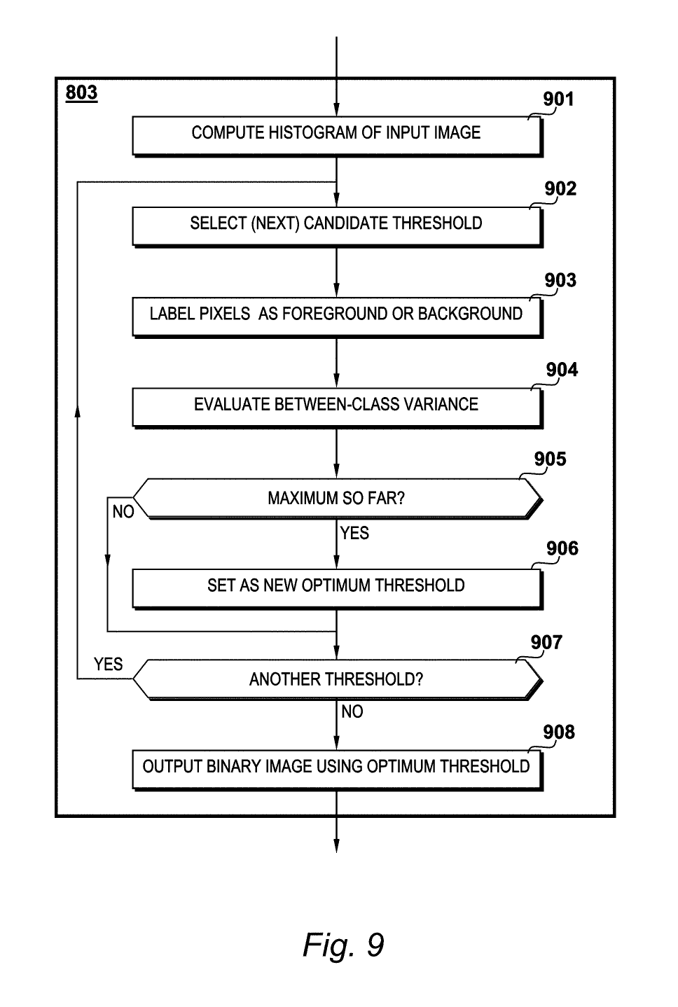

At step 801, an image stored on the solid-state disk 403 at step 604 is loaded into memory for processing. At step 802, the image is converted into a binary image, i.e. pixels are classified as either foreground pixels or background pixels depending upon their level in relation to a threshold. In the present embodiment, the threshold is one of a number of possible candidate thresholds. Selection of the candidate threshold to be used for foreground/background classification may performed unsupervised and automatically. This process will be described further with reference to FIG. 9. In alternative implementations, the threshold may be chosen manually, or may be fixed.

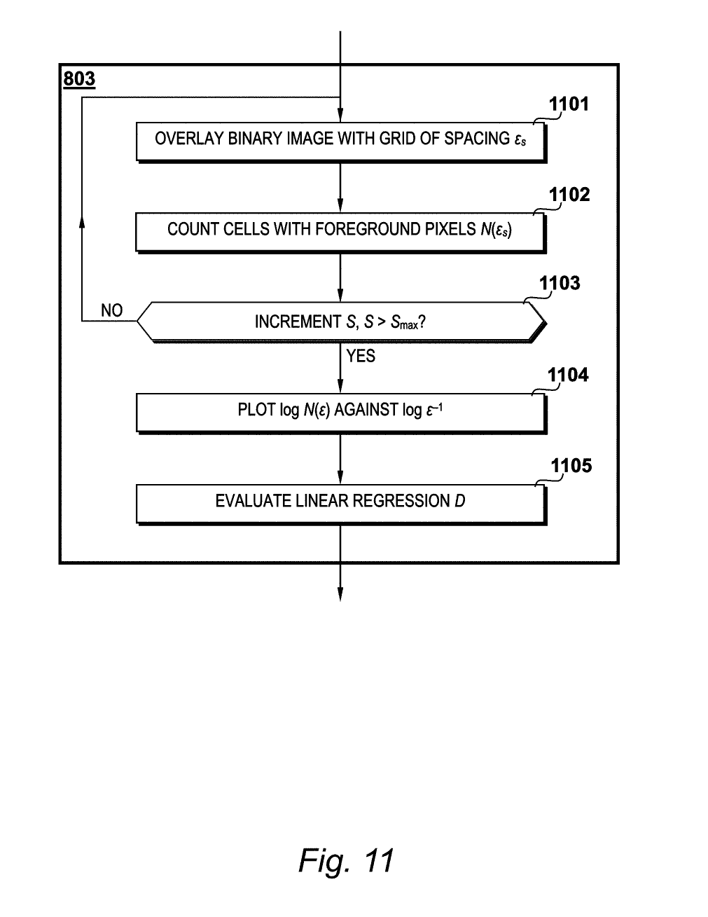

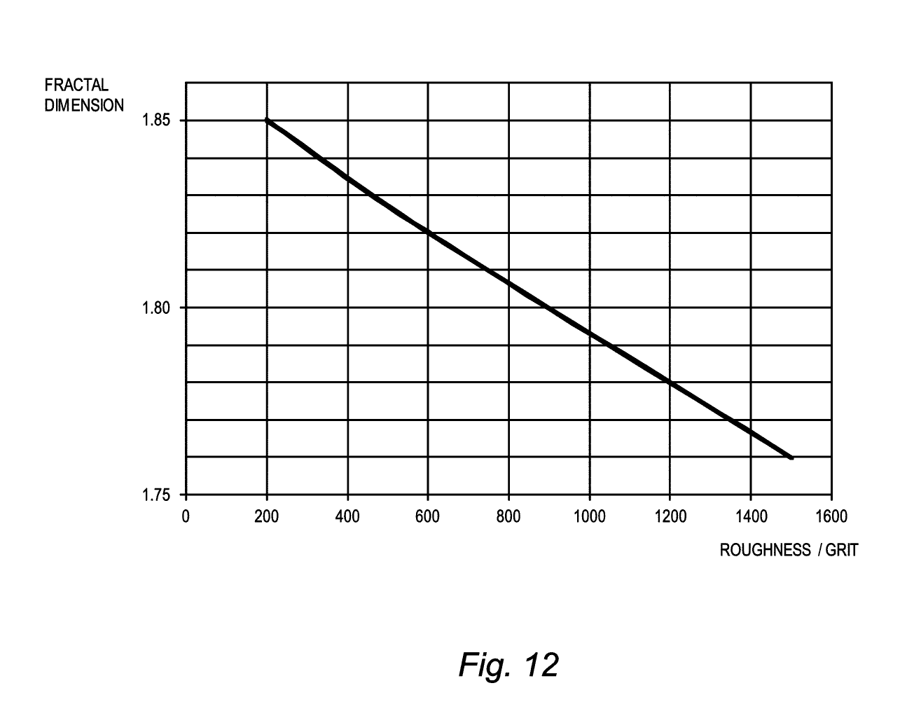

The fractal dimension of the binary image is then evaluated at step 803, which process will be described with reference to FIG. 11. In the present embodiment, the box-counting or Minkowski-Bouligand dimension is evaluated, although it will be appreciated that other fractal dimensions may be evaluated as an alternative. As will be described further with reference to FIG. 12, the fractal dimension of an image correlates with the roughness of a surface.

In this way, an indication of a measure of the surface roughness may be output at step 804 by using a lookup table stored in memory to convert a fractal dimension into a measure of roughness, for example. Alternatively, a relation may be derived from empirical testing which may be stored as part of the program instructions of the present invention, which is then used during step 804 to convert the fractal dimension into a measure of surface roughness.

Following production of a measure of the roughness for the surface that caused the speckle pattern which was the subject of the image loaded at step 801, a question is asked at step 805 as to whether any other images are to be processed. If so, control returns to step 801 where the next image is loaded for processing. If not, then the question is answered in the negative and step 506 is complete.

As described previously, in the present embodiment the procedure for conversion into a binary image may be carried out unsupervised and automatically. The processes carried out during step 802 to achieve this are set out in FIG. 9.

At step 901, the histogram of the image loaded into memory at step 801 is computed. As will be familiar to those skilled in the art, the histogram of an image comprises bins, each one of which represents a certain level. Each bin records the number of pixels in the image having that particular level.

At step 902, a candidate threshold is selected. For the present case where the images produced by the camera 304 are 8 bit greyscale images, there may be 254 thresholds, corresponding to levels 1 to 254, which would respectively split the image into background pixels of level 0 and foreground pixels of level 1 and over, and background pixels of level 254 and under and foreground pixels of level 255. However, it will be appreciated that any number of thresholds could be provided, in any distribution. Thus for example, there may be 32 candidate thresholds, each separated by 8 levels. Alternatively, the distribution of thresholds may resemble a gamma curve for example, with lower level thresholds being more spaced apart than higher ones, for example.

Thus at step 903 the pixels in the image are classified as either foreground pixels if they are of greater than or equal level to the threshold, or background pixels if they are lower in level than the threshold.

The histogram produced at step 901 is then utilised to perform step 904. In this step, the background pixels are considered a class C₀ and the background pixels are another class C₁. The probabilities of class occurrence or weights are ω₀ and ω₁, which are the zeroth order cumulative moments of the histogram either side of the threshold. The class mean levels are μ₀ and μ₁, which are the first order cumulative moments of the histogram either side of the threshold.

It may be shown that the optimum threshold is located at a point where there is both the lowest variance in the levels of the background pixels and the lowest variance in the levels of the background pixels, i.e. a minimised within-class variance. It may be shown that maximising the between-class variance is equivalent to minimising the within-class variance, and is more computationally efficient.

The between-class variance σ_{B}² is evaluated by calculating the product of the weights, multiplied by the square of the difference between the background mean and the foreground mean, i.e. ω₀ω₁(μ₀−μ₁)².

At step 905, a question is asked as to whether the value of σ_{B}² evaluated at step 904 is the maximum thus far. If so, then the candidate threshold selected at the current iteration of step 902 is set as the new optimum threshold. Then, or if the question asked at step 905 was answered in the negative, then a further question is asked as to whether another candidate threshold needs to be considered. If so, control returns to step 902 where the next candidate threshold is selected. If not, then control proceeds to step 908 where a binary image is outputted utilising the optimum threshold.

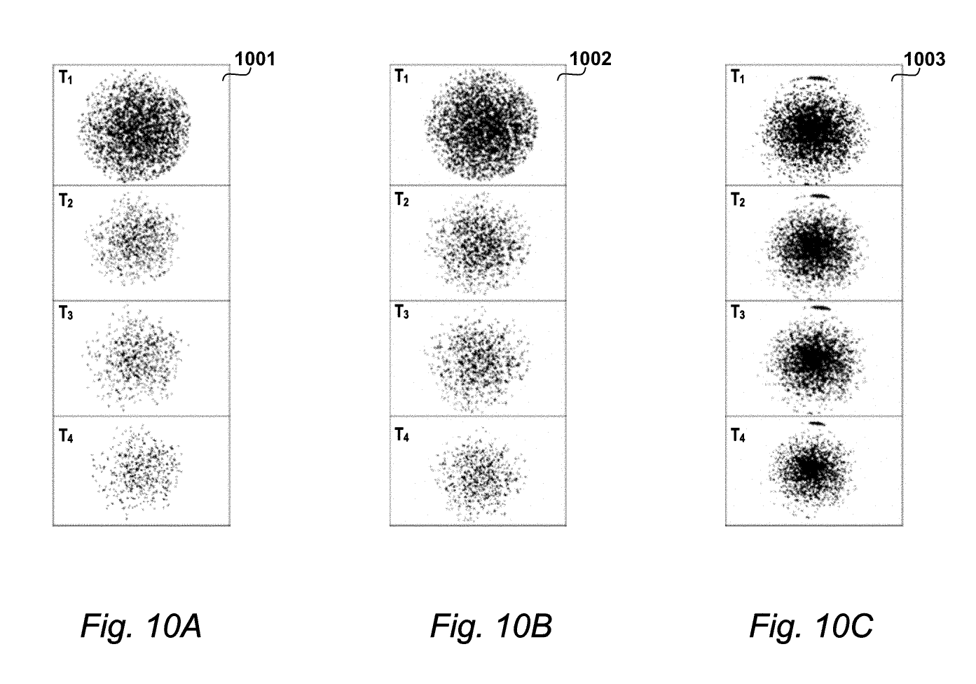

Binary images derived from the images of the speckle patterns 701, 702 and 703 are shown in FIGS. 10A, 10B and 100 respectively. The binary images were obtained by utilising four different candidate thresholds T₁ to T₄ during step 802. In the present example, binary images 1001, 1002, and 1003, derived from image 701, 702, and 703 respectively using a threshold T₁, were deemed to exhibit the maximal between-class variance. Thus threshold T₁ was selected as the threshold to use for the output step 908 for each iteration of step 802 as step 506 was applied to images 701, 702 and 703. (It will be appreciated that given different input images more thresholds the result would be likely to be different.)

Procedures carried out to evaluate the fractal dimension of the binary image during step 803, are set out in FIG. 11.

As described previously, in the present embodiment the fractal dimension that is evaluated is the box-counting dimension, and thus step 804 evaluates this measure. It is however contemplated that other fractal dimensions may be measured, such as the Hausdorff or correlation dimensions.

Implementing in this example therefore the measurement of the box-counting dimension, at step 1101 a grid with regular spacing ε_{S} is overlaid on the binary image produced at step 802. In this example, S is an integer and provides an index to an array defining the grid cell sizes to utilise. In the present example, the cell sizes range from the size of the binary images, down to the pixel size. However, the number of grid cell sizes and how they partition the images may be varied depending upon the accuracy and/or processing speed required.

At step 1102, the number of cells in the grid that contain at least one foreground pixels, N(ε_{S}), is counted and stored for subsequent processing. At step 1103, the integer S is incremented and a question is asked as to whether it is now greater than the largest value it may have, S_{MAX}. If not, then there is another grid cell size to use and control therefore returns to step 1102.

Eventually, all grid cell sizes will be used and so control will proceed to step 1105, where a log-log plot is made of N(ε) against ε⁻¹. At step 1106, the linear regression D of the points on the log-log plot is evaluated—this is the box-counting dimension of the binary image.

A plot of surface roughness—in this case grit number—against fractal dimension—in this case the box-counting dimension—is shown in FIG. 12.

As described previously, and as may be seen from the plot, it has been found by the present inventors that there is a relationship between the roughness of a surface, and the fractal dimension of binary images derived from images of the speckle pattern caused by scattering of coherent light from the surface. In this case, there is a positive correlation, as the higher the roughness (the lower the grit number), the higher the fractal dimension.

It will be appreciated by those skilled in the art that the conversion to a binary image does impose latency in terms of the processing of the image loaded at step 801. However, the use of a binary image for the basis of determining the fractal dimension means that a significant reduction in processing time at step 803 is achieved.

This is because the binary image simply classifies each pixel as being in one of two states, allowing the fractal dimension to be directly evaluated. By contrast, greyscale images, where each pixel may occupy one of a plurality of levels (e.g. 256 for an 8 bit image), require for example the differential box counting technique to be used, in which the output is only ever an estimate of the fractal dimension. In addition, the algorithmic complexity of such procedures causes far greater increases in processing time, than the inclusion of the conversion to a binary image as performed in the present invention.

Due to the reduction in processing time required by steps 802 and 803 it is envisaged that the present invention may be applied as part of a quality control measurement process within a live production environment.

It will be understood that the invention is not limited to the embodiments described herein, and various modifications and improvements can be made without departing from the concepts described. Except where mutually exclusive, any of the features may be employed separately or in combination with any other features and the invention extends to and includes all combinations and sub-combinations of one or more features described herein.

1. A computer-implemented method to determine surface roughness, comprising:
obtaining an image of speckle caused by the scattering of coherent light from a surface;
converting the image into a binary image according to a threshold, thereby classifying pixels below the threshold as background pixels and pixels above the threshold as foreground pixels; and
evaluating the fractal dimension of the binary image, wherein the fractal dimension correlates with surface roughness;
outputting an indication of the surface roughness of the surface.

2. The method of claim 1, further comprising selecting the threshold from a plurality of candidate thresholds.

3. The method of claim 2, in which the selection from a plurality of candidate thresholds is performed unsupervised and automatically.

4. The method of claim 2, in which the threshold that is selected is the candidate threshold which produces a binary image with both the lowest variance in level between pixels classified as foreground pixels and the lowest variance between pixels classified as background pixels.

5. The method of claim 1, in which the fractal dimension is the box-counting dimension.

6. The method of claim 1, in which obtaining an image of speckle comprises:
directing a coherent illumination device towards the surface;
imaging the speckle pattern with an imaging device.

7. The method of claim 6, in which the coherent illumination device is a laser.

8. The method of claim 6, in which:
the coherent illumination device generates light in the infrared band; and
the imaging device is sensitive to the infrared band.

9. A non-transitory computer-readable medium having computer-executable instructions encoded thereon which, when executed by a computer, cause the computer to determine surface roughness by:
obtaining an image of speckle caused by the scattering of coherent light from a surface;
converting the image into a binary image according to a threshold, thereby classifying pixels below the threshold as background pixels and pixels above the threshold as foreground pixels; and
evaluating the fractal dimension of the binary image, wherein the fractal dimension correlates with surface roughness;
outputting an indication of the surface roughness of the surface.

10. The non-transitory computer-readable medium of claim 9, further comprising selecting the threshold from a plurality of candidate thresholds.

11. The non-transitory computer-readable medium of claim 10, in which the selection from a plurality of candidate thresholds is performed unsupervised and automatically.

12. The non-transitory computer-readable medium of claim 10, in which the threshold that is selected is the candidate threshold which produces a binary image with both the lowest variance in level between pixels classified as foreground pixels and the lowest variance between pixels classified as background pixels.

13. The non-transitory computer-readable medium of claim 9, in which the fractal dimension is the box-counting dimension.

14. The non-transitory computer-readable medium of claim 9, in which obtaining an image of speckle comprises:
directing a coherent illumination device towards the surface;
imaging the speckle pattern with an imaging device.

15. The non-transitory computer-readable medium of claim 14, in which:
the coherent illumination device generates light in the infrared band; and
the imaging device is sensitive to the infrared band.

16. A measurement system for determining the roughness of a surface, comprising:
a coherent illumination device configured to illuminate the surface with coherent light;
an imaging device configured to obtain an image of speckle caused by the scattering of the coherent light from the surface; and
a processing device configured to:
convert the image into a binary image according to a threshold, thereby classifying pixels below the threshold as background pixels and pixels above the threshold as foreground pixels,
evaluate the fractal dimension of the binary image, wherein the fractal dimension correlates with surface roughness, and
output an indication of the surface roughness of the surface.

17. The measurement system of claim 16, in which the processing device is configured to select the threshold from a plurality of candidate thresholds.

18. The measurement system of claim 17, in which the processing device is configured to perform the selection from the plurality of candidate thresholds unsupervised and automatically.

19. The measurement system of claim 17, in which the processing device is configured to select the candidate threshold which produces a binary image with both the lowest variance in level between pixels classified as foreground pixels and the lowest variance between pixels classified as background pixels.

20. The measurement system of claim 16, in which the fractal dimension the processing device is configured to evaluate is the box-counting dimension.
